(19) United States
(12) Patent Application Publication
(10) Pub. No.: US 2026/0230566 A1
(43) Pub. Date: Aug. 6, 2026

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventors: Seiji SHIMOYAMA, Tokyo (JP); Takeru KONO, Tokyo (JP); Nemu OZAWA, Tokyo (JP); Makiko BUJO, Tokyo (JP)

(73) Assignee: FUJIFILM Business Innovation Corp., Tokyo (JP)

(21) Appl. No.: 19/285,540

(22) Filed: Jul. 30, 2025

(30) Foreign Application Priority Data
Feb. 5, 2025 (JP) 2025-017943

(51) Int. Cl. H04N 1/00; G06F 40/103

(52) U.S. Cl. CPC H04N 1/00196; G06F 40/103; H04N 1/00456

(57) ABSTRACT

An information processing system uses pieces of content that a user selects to create an album, and includes a processor configured to: when the user for whom no attribute has been set selects pieces of content to be included in the album, present to the user, recommended pieces of content for when there is no attribute of a user; and when the user has selected a predetermined number of pieces of content, associate an attribute identified based on the selected pieces of content with the user, and present to the user the recommended pieces of content based on the identified attribute by using an estimation model that estimates recommended pieces of content based on an attribute of a user.

### CROSS-REFERENCE TO RELATED APPLICATIONS

This application is based on and claims priority under 35 USC 119 from Japanese Patent Application No. 2025-017943 filed Feb. 5, 2025.

### BACKGROUND

### (i) Technical Field

The present disclosure relates to an information processing system and a non-transitory computer readable medium.

### (ii) Related Art

Japanese Unexamined Patent Application Publication No. 2022-128956 discloses an information processing system including a first acquisition portion that acquires a viewing-and-listening history of pieces of broadcast content that a user has viewed and/or listened, a second acquisition portion that acquires subject information related to a subject included in captured image data that the user possesses, an estimation portion that estimates attribute information indicating a preference of the user for the pieces of broadcast content based on the viewing-and-listening history that the first acquisition portion has acquired and the subject information that the second acquisition portion has acquired, and a presentation portion that presents information corresponding to the attribute information that the estimation portion has estimated to the user.

### SUMMARY

There is a site that uses pieces of content that a user selects to create, sell, and provide an album, for example. There is, for example, a content-selling site that creates and sells an album as a user selects pieces of content such as photographs or videos. Note herein that, when the user desires to select pieces of content, recommended pieces of content may be presented. It is assumed that recommended pieces of content may be determined based on pieces of content that another user has selected and an attribute of the user attempting to receive provision of an album.

However, those that are possible to be presented are only recommended pieces of content that may be widely acceptable for a user for whom no attribute has been set, who has not yet received provision of pieces of content, for example.

Aspects of non-limiting embodiments of the present disclosure relate to an information processing system and an information processing program that make it possible to present, even for a user for whom no attribute has been set, recommended pieces of content in which an attribute of the user has been taken into account.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system that uses pieces of content that a user selects to create an album, the information processing system including a processor configured to: when the user for whom no attribute has been set selects pieces of content to be included in the album, present to the user, recommended pieces of content for when there is no attribute of a user; and when the user has selected a predetermined number of pieces of content, associate an attribute identified based on the selected pieces of content with the user, and present to the user the recommended pieces of content based on the identified attribute by using an estimation model that estimates recommended pieces of content based on an attribute of a user.

### BRIEF DESCRIPTION OF THE DRAWINGS

An exemplary embodiment of the present disclosure will be described in detail based on the following figures, wherein:

FIG. 1 is a diagram illustrating a schematic configuration of an information processing system according to the present exemplary embodiment;

FIG. 2 is a block diagram illustrating a configuration of a main portion in an electrical system in a printing apparatus in the information processing system according to the present exemplary embodiment;

FIG. 3 is a block diagram illustrating configurations of main portions in electrical systems in a server and a user terminal in the information processing system according to the present exemplary embodiment;

FIG. 4 is a functional block diagram illustrating a functional configuration of the server in the information processing system according to the present exemplary embodiment;

FIG. 5 is a diagram illustrating an example of a screen that presents recommended pieces of content;

FIG. 6 is a flowchart illustrating an example of a flow of recommendation image presentation processing performed in the server in the information processing system according to the present exemplary embodiment; and

FIG. 7 is a flowchart illustrating the example of the flow of the recommendation image presentation processing performed in the server in the information processing system according to the present exemplary embodiment.

### DETAILED DESCRIPTION

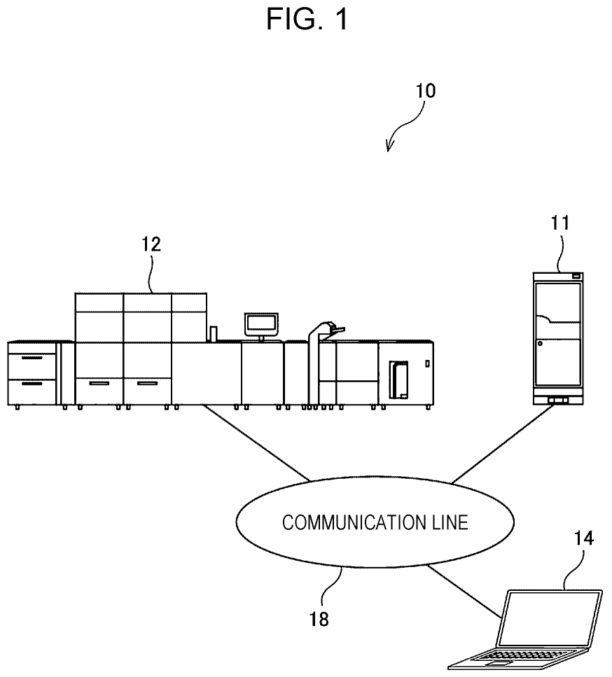

An example of the present exemplary embodiment will now be described herein in detail with reference to the accompanying drawings. In the present exemplary embodiment, it will be described, as an example, an information processing system in which a user terminal, a printing apparatus, and a server, for example, are coupled to each other via a communication line such as a network that varies in type. FIG. 1 is a diagram illustrating a schematic configuration of an information processing system 10 according to the present exemplary embodiment.

As illustrated in FIG. 1, the information processing system 10 according to the present exemplary embodiment includes a server 11, a printing apparatus 12, and a user terminal 14, for example. The server 11, the printing apparatus 12, and the user terminal 14 are coupled to each other via a communication line 18 such as a local area network (LAN), a wide area network (WAN), the Internet, or an intranet. Then, the server 11, the printing apparatus 12, and the user terminal 14 are capable of transmitting and receiving various types of data to and from each other via the communication line 18. In the present exemplary embodiment, when the server 11 instructs the printing apparatus 12 to print an album including images selected via the user terminal 14, the printing apparatus 12 forms the images in accordance with the print instruction.

Note that, although FIG. 1 illustrates a single server 11, a single printing apparatus 12, and a single user terminal 14, all or some of the server, printing apparatus, and the user terminal may be plural in number.

The printing apparatus 12 according to the present exemplary embodiment has a plurality of functions such as a printing function of performing printing processing and a post-processing function of performing post-processing on a printed sheet. The plurality of functions may include a reading function of reading a document to acquire image information representing the document, a copying function of copying an image recorded on a document to a sheet, a facsimile function of transmitting and receiving various types of data via a non-illustrated telephone line, a transfer function of transferring document information such as image information read through the reading function or another function, and a storage function of storing document information such as image information that has been read.

Note that, the facsimile function, the reading function, the printing function, and the copying function may be hereinafter respectively referred to as “fax”, “scan”, “print”, and “copy”.

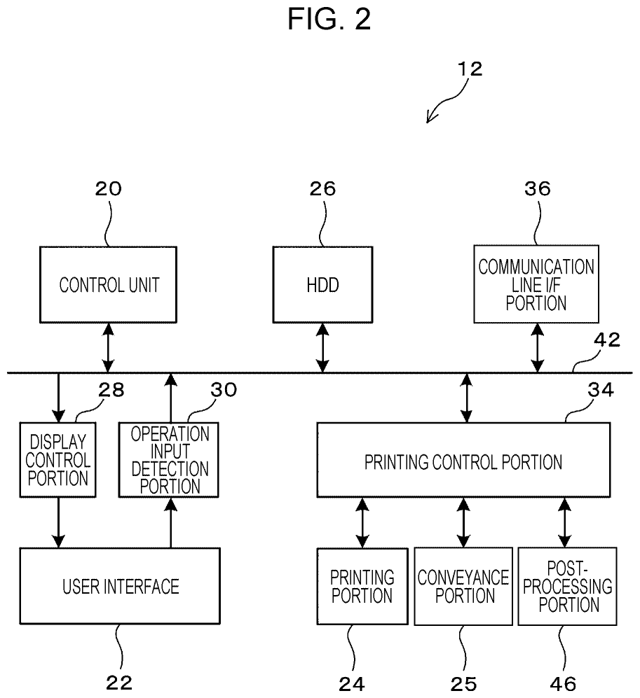

FIG. 2 is a block diagram illustrating a configuration of a main portion in an electrical system in the printing apparatus 12 in the information processing system 10 according to the present exemplary embodiment.

As illustrated in FIG. 2, the printing apparatus 12 according to the present exemplary embodiment includes a control unit 20. The control unit 20 may include a central processing unit (CPU), a read-only memory (ROM), and a random-access memory (RAM).

On the other hand, the printing apparatus 12 according to the present exemplary embodiment includes a hard disk drive (HDD) 26 that stores various types of data and application programs, for example. Furthermore, the printing apparatus 12 includes a display control portion 28 that is coupled to a user interface 22 and controls displaying of various types of operation screens and other screens on a display of the user interface 22. Furthermore, the printing apparatus 12 includes an operation input detection portion 30 that is coupled to the user interface 22 and detects an operation instruction inputted via the user interface 22. Then, in the printing apparatus 12, the HDD 26, the display control portion 28, and the operation input detection portion 30 are electrically coupled to the system bus 42. Note that, although the printing apparatus 12 according to the present exemplary embodiment employs, but not limited to, the HDD 26 as a storage portion, a non-volatile storage portion such as flash memory may be employed. Furthermore, although, in the present exemplary embodiment, the user interface 22 employs, but not limited to, a touch panel capable of achieving displaying and allowing an operation input to be performed, user interfaces in which a display and an operation portion are separated from each other may be employed.

Furthermore, the printing apparatus 12 according to the present exemplary embodiment includes a printing control portion 34 that controls printing processing that a printing portion 24 performs, conveying of a sheet to the printing portion 24, which a conveyance portion 25 performs, and post-processing that a post-processing portion 46 performs. The printing apparatus 12 may include a reading control portion that controls an optical reading operation of an image, which a document reading portion performs, and a document conveying operation that a document conveyance portion performs. Furthermore, the printing apparatus 12 includes a communication line interface (I/F) portion 36 that is coupled to the communication line 18, through which communication data is transmitted to and received from another external device such as the server 11 coupled to the communication line 18. Furthermore, the printing apparatus 12 may include a facsimile interface (I/F) portion that is coupled to a non-illustrated telephone line, through which facsimile data is transmitted to and received from a facsimile apparatus coupled to the telephone line. Furthermore, the printing apparatus 12 may include a transmission/reception control portion that controls transmission and reception of facsimile data via a facsimile I/F portion 38. Then, in the printing apparatus 12, the printing control portion 34 and the communication line I/F portion 36 are electrically coupled to the system bus 42.

With the configuration described above, the printing apparatus 12 according to the present exemplary embodiment causes the control unit 20 to execute control of displaying of information such as operation screens and various types of messages on the display of the user interface 22 via the display control portion 28. Furthermore, the printing apparatus 12 causes the control unit 20 to execute control of operation of the printing portion 24, the conveyance portion 25, and the post-processing portion 46 via the printing control portion 34 and control of transmission and reception of communication data via the communication line I/F portion 36. In addition, the printing apparatus 12 causes the control unit 20 to know content of an operation performed on the user interface 22 based on operation information that the operation input detection portion 30 detects and perform various types of control based on the content of the operation.

Note that, in the present exemplary embodiment, examples of applications stored in the HDD 26 include applications for executing functions such as printing.

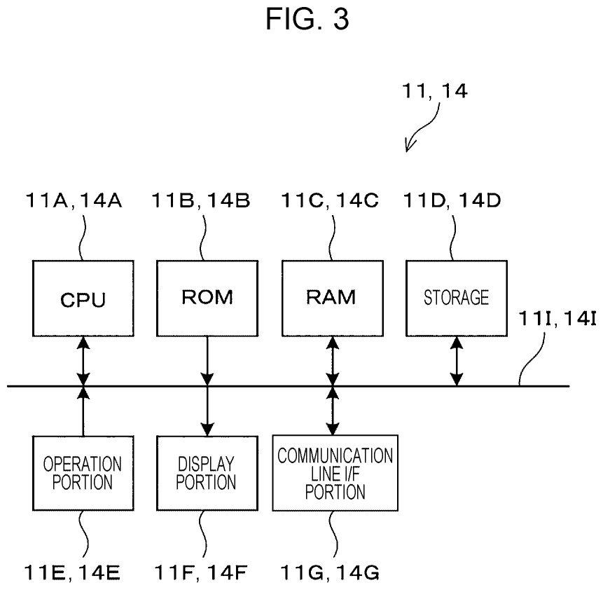

Next, configurations of main portions in electrical systems in the server 11 and the user terminal 14 according to the present exemplary embodiment will now be described herein. FIG. 3 is a block diagram illustrating the configurations of the main portions in the electrical systems in the server 11 and the user terminal 14 in the information processing system 10 according to the present exemplary embodiment. Note that, since the server 11 and the user terminal 14 have general computer configurations, the server 11 will now be described herein as a representative example. Note that the user terminal 14 may be a mobile terminal such as a smartphone.

As illustrated in FIG. 3, the server 11 according to the present exemplary embodiment includes a CPU 11A serving as an example processor, a ROM 11B, a RAM 11C, a storage 11D, an operation portion 11E, a display portion 11F, and a communication line interface (I/F) portion 11G. The CPU 11A wholly governs the server 11 in operation. The ROM 11B stores in advance various types of control programs and various types of parameters, for example. The RAM 11C is used as a work area, for example, when the CPU 11A executes various types of programs. The storage 11D stores various types of data and application programs, for example. The operation portion 11E is used to input various types of information. The display portion 11F is used to display various types of information. The communication line I/F portion 11G is coupled to the communication line 18, through which various types of data are transmitted to and received from other apparatuses coupled to the communication line 18. Furthermore, the communication line I/F portion 11G may be configured to directly communicate with each apparatus using various types of known wireless communications. The portions described above in the server 11 are electrically coupled to each other via a system bus 11I. Note that, the server 11 according to the present exemplary embodiment employs the storage 11D as a storage portion, but, as an example storage, a non-volatile storage portion such as a hard disk drive (HDD) or a flash memory may be used.

With the configuration described above, the server 11 according to the present exemplary embodiment causes the CPU 11A to execute accessing to the ROM 11B, the RAM 11C, and the storage 11D, acquiring of various types of data via the operation portion 11E, and displaying of various types of information on the display portion 11F. Furthermore, the server 11 causes the CPU 11A to execute controlling of transmission and reception of communication data via the communication line I/F portion 11G.

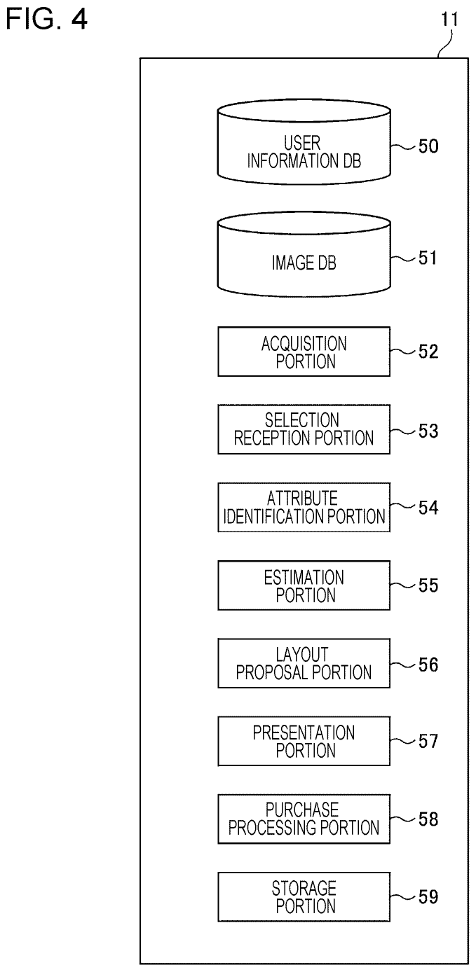

Next, a functional configuration of the server 11 will now be described herein. FIG. 4 is a block diagram illustrating an example functional configuration of the server 11.

As illustrated in FIG. 4, the server 11 is configured to functionally include a user information database (DB) 50, an image database (DB) 51, an acquisition portion 52, a selection reception portion 53, an attribute identification portion 54, an estimation portion 55, a layout proposal portion 56, a presentation portion 57, a purchase processing portion 58, and a storage portion 59.

In the present exemplary embodiment, it will be described an example case where images that a user selects from a group of images captured at an event where a group of at least two persons appears to create an album.

The user information database (DB) 50 stores a purchase history of each of users and an attribute of each of the users, which the storage portion 59 has stored.

Note herein that examples of the attribute of each of the users include a plurality of attributes each indicating a preference for a different person, an attribute indicating a preference for all persons appearing at an event, and an attribute indicating a preference for a group of some of the persons appearing at the event.

Examples of the attribute of each of the users include, for example, an attribute representing that a certain idle group X is wholly supported, an attribute representing that a certain person A in the certain idle group is supported, an attribute representing that a certain person B in the certain idle group is supported, and an attribute representing that a certain person C in the certain idle group is supported.

The image database (DB) 51 stores a group of images captured at an event where a group of at least two persons appears.

For example, the event is a music live event at which an idol group appears, or such events held a plurality of times. Each image included in the group of the images stored in the image DB 51 is assigned with identification information (for example, a date) for identifying an event at which the image has been captured.

Furthermore, each image included in the group of the images stored in the image DB 51 is assigned with at least one of a plurality of types of tags.

The plurality of types of tags include a tag including information for identifying a person appearing in the image, a tag indicating that all persons appearing at the event are represented, and a tag indicating that a group of at least two persons appearing at the event is represented.

For example, the plurality of types of tags include a tag indicating that the person A is represented, a tag indicating that the person B is represented, a tag indicating that the person C is represented, and a tag indicating that all the persons of the idol group X are represented.

Note herein that a ticket for participating in an event indicates a two-dimensional code for creating an album corresponding to the event.

As information indicating a two-dimensional code is received from the user terminal 14, the acquisition portion 52 acquires, from the image DB 51, a plurality of images representing an event corresponding to the two-dimensional code. Thereby, the plurality of images captured at the event corresponding to the ticket that the user possesses are acquired from the image DB 51.

When no information indicating a two-dimensional code is received from the user terminal 14, the acquisition portion 52 acquires, from the image DB 51, pluralities of images respectively representing events held a plurality of times. Thereby, a plurality of images captured at each of events held a plurality of times are acquired from the image DB 51.

The selection reception portion 53 receives, from the user terminal 14, selection of images to be included in an album from among the plurality of images that the presentation portion 57 presents.

Note that, although, in the present exemplary embodiment, it will be described, but not limited to, an example case where an album that the printing apparatus 12 prints is to be created, an album in a form of digital data on a cloud or a group of photographs (group folder) named as an album may be created.

When the user has selected a predetermined number of images, the attribute identification portion 54 identifies an attribute of the user based on the selected images.

Specifically, the attribute identification portion 54 identifies the attribute of the user based on the types of the tags assigned to the plurality of images that the user has selected.

For example, when a ratio of the tags indicating that the person A is represented among the plurality of tags assigned to the plurality of images that the user has selected is equal to or greater than a threshold value, the attribute identification portion 54 identifies an attribute representing that the person A is supported as the attribute of the user. Furthermore, when the ratio of the tags indicating that all the persons of the idol group X are supported among the plurality of tags assigned to the plurality of images that the user has selected is equal to or greater than a threshold value, the attribute identification portion 54 identifies an attribute representing that all the persons of the idol group X are supported as the attribute of the user.

When the user information DB 50 has already stored the attribute of the user, the estimation portion 55 uses an estimation model that estimates recommended images based on an attribute of a user to estimate recommended images based on the already stored attribute of the user. Note that, the recommended images are an example of recommended pieces of content.

When no attribute of the user is set and no attribute of the user is stored in the user information DB 50, the estimation portion 55 uses the estimation model to estimate recommended images based on an attribute that the attribute identification portion 54 has identified.

Note herein that, it is sufficient to use, as the estimation model that estimates recommended images, for example, a model that estimates, based on the attribute and a purchase history of each user, a plurality of images selected for an album that another user having the identical attribute has purchased as recommended images, and, otherwise, a neural network model may be used.

The layout proposal portion 56 proposes a layout of each of pages of an album. Example layouts to be proposed include a layout in which at least one image is disposed on each of left and right pages and a layout in which one image is disposed on pages that appear in a two-page spread style.

When the user information DB 50 has already stored the attribute of the user, the presentation portion 57 causes the user terminal 14 to present recommended images based on the attribute of the user.

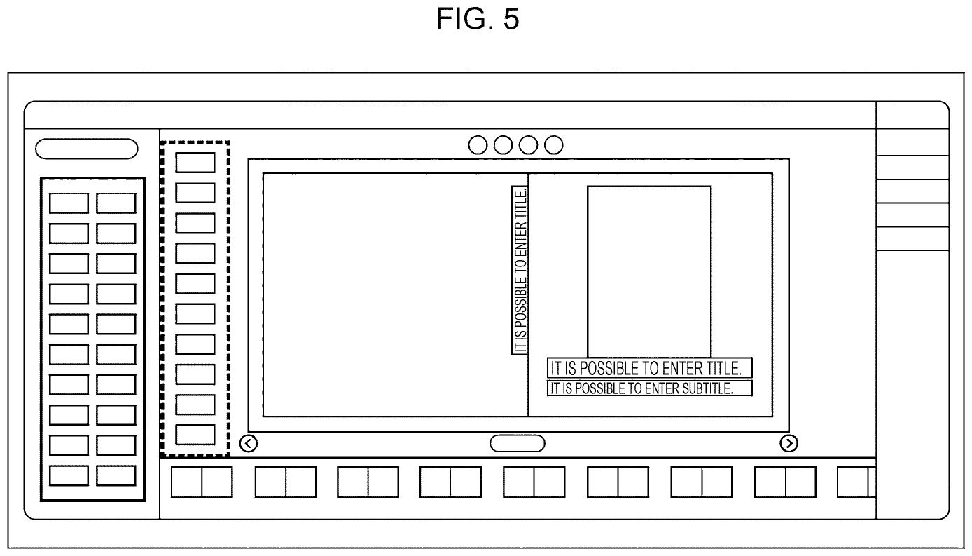

For example, as illustrated in FIG. 5, the user terminal 14 presents recommended images (see those inside a frame surrounded by a dashed line in FIG. 5) together with a layout proposed for the page of the album. At this time, the selection reception portion 53 receives, from the user terminal 14, an operation of dragging and dropping one image or some images selected from among the recommended images or all images (see those in a frame surrounded by a thick line in FIG. 5) to an image disposition portion in the layout.

FIG. 5 illustrates an example of presenting ten recommended images and all pages in a lower row in a display screen. Furthermore, FIG. 5 illustrates an example of presenting a layout of disposing a horizontal image on a left page and a vertical image on a right page.

Furthermore, when the user for whom no attribute has been set selects images to be included in an album, the presentation portion 57 causes the user terminal 14 to present recommended images for when there is no attribute of a user.

Specifically, when the user information DB 50 has stored no attribute of the user and the attribute identification portion 54 identifies no attribute, the presentation portion 57 causes the user terminal 14 to present recommended images for when there is no attribute of a user.

For example, the presentation portion 57 causes the user terminal 14 to present images that are requested in advance based on a purchase history of each user and that many users have selected or purchased as recommended images for when there is no attribute of a user.

When the user information DB 50 has stored no attribute of the user, but the attribute identification portion 54 has identified an attribute, the presentation portion 57 causes the user terminal 14 to present recommended images based on the identified attribute.

Furthermore, the presentation portion 57 causes the user terminal 14 to display, as recommended images for when there is no attribute of a user, a plurality of recommended images allowing a number of the images each assigned with a tag indicating that a group appearing at the event is represented to correspond to a number of the images each assigned with a tag indicating that a certain person is represented.

For example, when ten recommended images are to be presented, the user terminal 14 presents, as recommended images, five images each assigned with a tag indicating that a group appearing at an event is represented and five images each assigned with a tag indicating that a certain person is represented.

Furthermore, when an attribute indicating a preference for a group appearing at an event is identified as the attribute of the user, the presentation portion 57 causes the user terminal 14 to present, as recommended images based on the identified attribute, a plurality of recommended images allowing the number of images each assigned with a tag indicating that the group appearing at the event is represented to be greater than the number of images each assigned with a tag indicating that the certain person is represented.

For example, when ten recommended images are to be presented, the user terminal 14 presents, as recommended images, seven images each assigned with a tag indicating that the group appearing at the event is represented and three images each assigned with a tag indicating that the certain person is represented.

Furthermore, when an attribute indicating a preference for the certain person A is identified as the attribute of the user, the presentation portion 57 causes the user terminal 14 to display, as recommended images based on the identified attribute, a plurality of recommended images allowing the number of images each assigned with a tag indicating that the certain person A is represented to be greater than the number of images assigned with a tag indicating that the group appearing at the event is represented.

For example, when ten recommended images are to be presented, the user terminal 14 presents, as recommended images, three images each assigned with a tag indicating that the group appearing at the event is represented and seven images each assigned with a tag indicating that the certain person A is represented.

Furthermore, when recommended images based on the identified attribute are to be presented to the user, the presentation portion 57 preferably causes a plurality of recommended images to be presented to the user to include a predetermined lower limit number (for example, one) of images each assigned with a tag indicating that the group appearing at the event is represented and a predetermined lower limit number (for example, one) of images each assigned with a tag indicating that the certain person is represented.

Furthermore, the presentation portion 57 may change the recommended images in accordance with a layout of each of pages of an album.

More specifically, for pages that are in the layout representing a two-page spread style, the presentation portion 57 may cause recommended images including images indicating, at its center, the preferred person that the identified attribute indicates to be presented.

Furthermore, for pages that are in the layout representing a two-page spread style and that correspond to the final page, the presentation portion 57 may cause recommended images including images each assigned with a tag indicating that the group appearing at the event is represented to be presented to the user.

Furthermore, the presentation portion 57 may cause, as recommended images, a plurality of images with an inter-image degree of similarity below a threshold value to be presented. Thereby, it is possible to prevent a plurality of images with similar configurations from being presented as recommended images.

When the purchase processing portion 58 receives, from the user terminal 14, an instruction for purchasing an album including the images selected via the user terminal 14, performs purchase processing, and transmits, to the printing apparatus 12, a print instruction for printing the album including the selected images.

When the album in which the selected images are used has not been purchased, the storage portion 59 deletes the attribute that the attribute identification portion 54 has identified and associated with the user.

When the album in which the selected images are used has been purchased, the storage portion 59 stores, in the user information DB 50, as the attribute of the user, the attribute that the attribute identification portion 54 has identified and associated with the user.

Next, specific processing that the information processing system 10 according to the present exemplary embodiment configured as described above performs will now be described herein.

On the user terminal 14, a request for using images selected from a group of images captured at an event at which a group of at least two persons appears to create an album is first transmitted to the server 11. Furthermore, when the user possesses a ticket for participating in the event, information indicating a two-dimensional code indicated on the ticket is acquired on the user terminal 14 and is transmitted to the server 11.

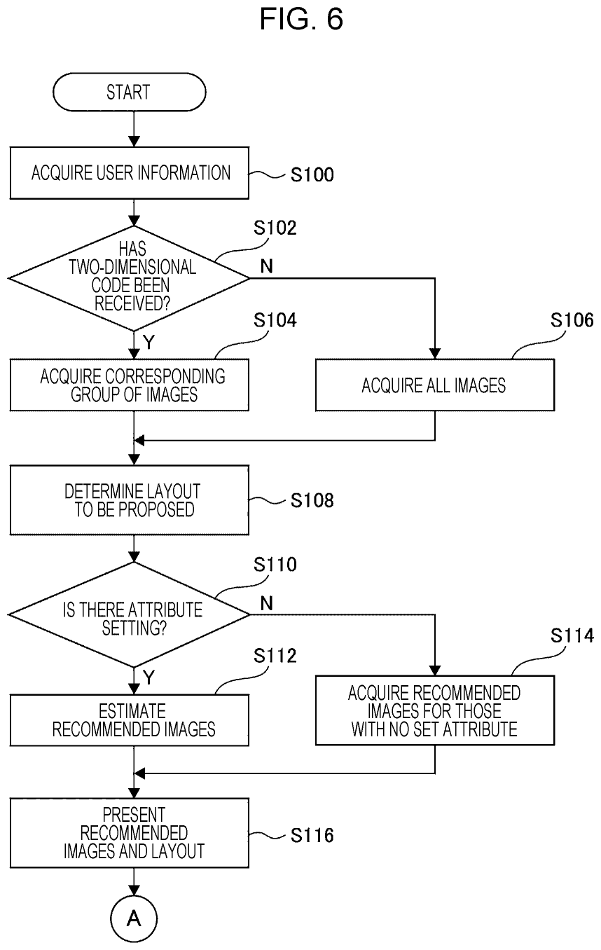

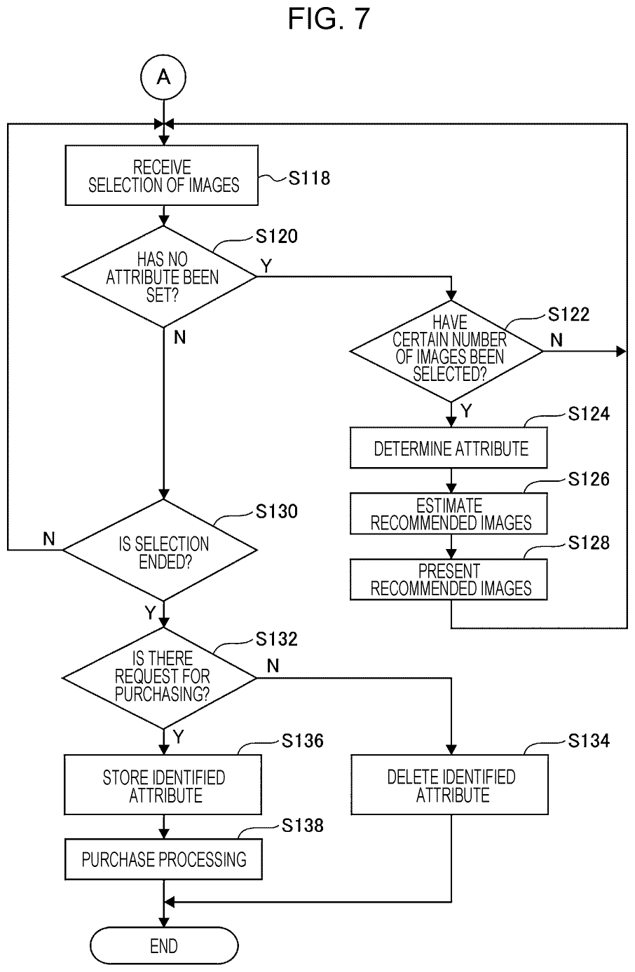

Next, as, in the server 11, the CPU 11A reads, from the ROM 11B or the storage 11D, deploys, in the RAM 11C, and executes an information processing program, recommended image presentation processing illustrated in FIGS. 6 and 7 is performed.

At step S100, the CPU 11A acquires user information including the attribute of the user from the user information DB 50.

At step S102, the CPU 11A serves as the acquisition portion 52 and determines whether or not information indicating a two-dimensional code is received from the user terminal 14. When information indicating a two-dimensional code is received from the user terminal 14, the processing proceeds to step S104. On the other hand, when no information indicating a two-dimensional code is received from the user terminal 14, the processing proceeds to step S106.

At step S104, when information indicating a two-dimensional code is received from the user terminal 14, the CPU 11A serves as the acquisition portion 52 and acquires, from the image DB 51, a plurality of images captured at the event corresponding to the two-dimensional code.

At step S106, when no information indicating a two-dimensional code is received from the user terminal 14, the CPU 11A serves as the acquisition portion 52 and acquires, from the image DB 51, pluralities of images respectively captured at events held a plurality of times.

At step S108, the CPU 11A serves as the layout proposal portion 56 and determines a layout to be proposed for each of pages of an album.

At step S110, the CPU 11A determines whether or not the attribute of the user has already been stored in the user information DB 50. When the user information acquired at step S110 described above includes the attribute of the user, the processing proceeds to step S112. On the other hand, when the user information acquired at step S110 described above does not include the attribute of the user, the processing proceeds to step S114.

At step S112, the CPU 11A serves as the estimation portion 55 and uses an estimation model that estimates recommended images based on an attribute of a user to estimate recommended images based on the attribute of the user.

At step S114, the CPU 11A serves as the presentation portion 57 and acquires images that are requested in advance based on a purchase history of each user and that many users have selected as recommended images for when there is no attribute of a user.

At step S116, the CPU 11A serves as the presentation portion 57 and causes the user terminal 14 to present, for each of the pages of the album, the layout determined at step S108 described above and the recommended images acquired at step S112 or S114 described above.

At step S118, the CPU 11A serves as the selection reception portion 53 and receives, from the user terminal 14, selection of images to be included in the album from among the plurality of images that the presentation portion 57 has presented.

At step S120, the CPU 11A determines whether or not the attribute of the user has already been stored in the user information DB 50. When the user information acquired at step S110 described above includes the attribute of the user, the processing proceeds to step S130. On the other hand, when the user information acquired at step S110 described above does not include the attribute of the user, the processing proceeds to step S122.

At step S122, the CPU 11A serves as the attribute identification portion 54 and determines whether or not the user has selected a predetermined number of images. When the user has selected a predetermined number of images, the processing proceeds to step S124. On the other hand, when the user has not yet selected the predetermined number of images, the processing returns to step S118 described above.

At step S124, the CPU 11A serves as the attribute identification portion 54 and identifies the attribute of the user based on the selected images.

At step S126, the CPU 11A serves as the estimation portion 55 and uses the estimation model to estimate recommended images based on the attribute identified at step S124 described above.

At step S128, the CPU 11A serves as the presentation portion 57 and causes the user terminal 14 to present the recommended images estimated at step S126 described above.

At step S130, the CPU 11A determines whether or not the user has finished selection of images. When the user has finished selection of images, the processing proceeds to step S132. On the other hand, when the user has not yet finished selection of images, the processing returns to step S118 described above.

At step S132, the CPU 11A determines whether not a request for purchasing the album has been received from the user terminal 14. When there is a request for purchasing the album, the processing proceeds to step S136. On the other hand, when there is no request for purchasing the album, the processing proceeds to step S134.

At step S134, the CPU 11A serves as the storage portion 59 and deletes the attribute that the attribute identification portion 54 has identified and associated with the user.

At step S136, the CPU 11A serves as the storage portion 59 and stores, in the user information DB 50, as the attribute of the user, the attribute that the attribute identification portion 54 has identified and associated with the user.

At step S138, the CPU 11A serves as the purchase processing portion 58 and receives, from the user terminal 14, an instruction for purchasing the album including the images selected via the user terminal 14, performs the purchase processing, and transmits, to the printing apparatus 12, a print instruction for instructing printing of the album including the selected images.

By performing the processing as described above, even when there is no purchase history of a user for whom no attribute has been set, it is possible to present recommended images for which the attribute of the user is taken into account when an album is to be created.

### Modification Examples

Note that, the present invention is not limited to the exemplary embodiment described above, and various types of modification examples and applications are possible within the scope of the present invention without departing from the gist of the present invention.

Although, in the present exemplary embodiment described above, it has been described an example case where images are used as pieces of content, the present invention is not limited to such an example case. As pieces of content, pieces of content other than images may be used, such as videos and audio data.

Furthermore, in the exemplary embodiment described above, a desired computer executes each of processes. Furthermore, the desired computer serving as a processor in a form of hardware, a program in a form of software, or a combination of the processor and the program may execute the processes. In this case, the processor is configured to perform the processes in the present exemplary embodiment in cooperation with the program and may function as a unit or a means in the exemplary embodiment. Furthermore, the order in which the processor performs the processes is not limited to the described order and may be changed appropriately. The desired computer may be a general-purpose computer, an application specific computer, a workstation, or another system capable of executing the processes.

The processor may be configured to include one piece or a plurality of pieces of hardware, and the hardware is not limited in type. For example, the processor may be configured to include a programmable logic device such as a central processing unit (CPU), a micro processing unit (MPU), or a field programmable gate array (FPGA), a dedicated circuit for executing a specific process, such as an application specific integrated circuit (ASIC), or hardware such as a graphic processing unit (GPU) or a neural processing unit (NPU). Furthermore, for the type of hardware, different types of hardware may be combined. When a plurality of pieces of hardware are configured to execute one or a plurality of processes for a processor, the plurality of pieces of hardware may be present in apparatuses physically away from each other or may be present in one apparatus. Furthermore, in the exemplary embodiment, the order in which the processor performs the processes is not limited to the order described above and may be changed appropriately. Note that the hardware is configured to include electric circuitry in which circuit elements such as semiconductor devices are combined, for example.

In addition, the program may be firmware or software such as a microcode. Furthermore, the program may be, for example, a program module group, and its functions may be implemented by processors configured to implement the respective functions. The program may be a program code or a plurality of code segments stored in one or a plurality of non-transitory computer readable media (for example, a storage medium or another storage). The program may be stored in such a divided manner in a plurality of non-transitory computer readable media present in apparatuses physically away from each other. The program code or the code segments may represent a procedure, a function, a sub program, a routine, a subroutine, a module, a software package, a class, or any combination of instructions, data structures, or program statements. The program code or the code segments may be coupled to another code segment or a hardware circuit through transmission and/or reception of information, data, an argument, a parameter, or a piece of content in a memory. Furthermore, the program according to the present application may be provided as a program product.

Furthermore, the present disclosure is not limited to those described above, and it is obvious that, in addition to those described above, the present disclosure is implementable in a variously modified manner within the scope of the present disclosure without departing from the gist of the present disclosure.

### Appendix

(((1)))

An information processing system that uses pieces of content that a user selects to create an album, the information processing system comprising a processor configured to: when the user for whom no attribute has been set selects pieces of content to be included in the album, present to the user, recommended pieces of content for when there is no attribute of a user; and when the user has selected a predetermined number of pieces of content, associate an attribute identified based on the selected pieces of content with the user, and present to the user the recommended pieces of content based on the identified attribute by using an estimation model that estimates recommended pieces of content based on an attribute of a user.

(((2)))

The information processing system according to (((1))), wherein the processor is configured to delete, when the album using the selected pieces of content is not purchased, the attribute associated with the user, and store, when the album using the selected pieces of content is purchased, the attribute associated with the user.

(((3)))

The information processing system according to (((1))) or (((2))), wherein each of the pieces of contents is assigned with at least one of a plurality of types of tags including a first tag and a second tag, and the processor is configured to present: to the user, as recommended pieces of content for when there is no attribute of the user, a plurality of recommended pieces of content to allow a number of pieces of content assigned with the first tag and a number of pieces of content assigned with the second tag to correspond to each other; when a first attribute corresponding to the first tag is identified as the attribute of the user, present to the user, as the recommended pieces of content based on the identified attribute, a plurality of recommended pieces of content to allow the number of pieces of content assigned with the first tag to be greater than the number of pieces of content assigned with the second tag; and when a second attribute corresponding to the second tag is identified as the attribute of the user, present to the user, as the recommended pieces of content based on the identified attribute, a plurality of recommended pieces of content to allow the number of pieces of content assigned with the second tag to be greater than the number of pieces of content assigned with the first tag.

(((4)))

The information processing system according to (((3))), wherein the processor is configured to when the recommended pieces of content based on the identified attribute are presented to the user, present to the user, the plurality of recommended pieces of content to include a predetermined lower limit number of the pieces of content assigned with the first tag and a predetermined lower limit number of the pieces of content assigned with the second tag.

(((5)))

The information processing system according to (((3))), wherein the first tag includes information identifying a person that each of the pieces of content represents, and the first attribute includes a plurality of attributes each indicating a preference for a different person.

(((6)))

The information processing system according to any one of (((1))) to (((5))), wherein the processor is configured to propose a layout of each of pages of the album, and change the recommended pieces of content in accordance with the layout of each of the pages of the album.

(((7)))

The information processing system according to (((5))), wherein the processor is configured to propose a layout of each of pages of the album, and present, for pages that are in the layout representing a two-page spread style, the recommended pieces of content including pieces of content indicating, at its center, the preferred person that the identified first attribute indicates.

(((8)))

The information processing system according to (((3))), wherein the pieces of content each represent an event where a plurality of persons appear, the second tag includes information indicating that all of the persons appearing at the event or a group including at least two of the persons appearing at the event is represented, the second attribute is an attribute indicating a preference for all or a group of some of the persons appearing at the event, and the processor is configured to: propose a layout of each of pages of the album; and present, for pages that are in the layout representing a two-page spread style and that correspond to a final page, the recommended pieces of content including pieces of content assigned with the second tag.

(((9)))

The information processing system according to any one of (((1))) to (((8))), wherein the processor is configured to present, as the recommended pieces of content, a plurality of pieces of content with an inter-content degree of similarity below a threshold value.

(((10)))

The information processing system according to any one of (((1))) to (((9))), wherein the pieces of content each represent an event, a ticket for participating in the event indicates a two-dimensional code for creating the album corresponding to the event, and the processor is configured to present, when information indicating the two-dimensional code is received from the user, the recommended pieces of content from among a plurality of pieces of content representing the event corresponding to the two-dimensional code.

(((11)))

The information processing system according to (((10))), wherein the event include events held a plurality of times, and the processor is configured to present, when no information indicating the two-dimensional code is received from the user, the recommended pieces of content from among a plurality of pieces of content representing the events held a plurality of times.

(((12)))

An information processing program causing a computer to execute a process for using pieces of content that a user selects to create an album, the process comprising: when the user for whom no attribute has been set selects pieces of content to be included in the album, presenting to the user, recommended pieces of content for when there is no attribute of a user; and when the user has selected a predetermined number of pieces of content, associating an attribute identified based on the selected pieces of content with the user, and presenting, to the user, the recommended pieces of content based on the identified attribute by using an estimation model that estimates recommended pieces of content based on an attribute of a user.

What is claimed is:

1. An information processing system that uses pieces of content that a user selects to create an album, the information processing system comprising:
a processor configured to:
when the user for whom no attribute has been set selects pieces of content to be included in the album, present to the user, recommended pieces of content for when there is no attribute of a user, and
when the user has selected a predetermined number of pieces of content, associate an attribute identified based on the selected pieces of content with the user, and present to the user the recommended pieces of content based on the identified attribute by using an estimation model that estimates recommended pieces of content based on an attribute of a user.

2. The information processing system according to claim 1, wherein the processor is configured to:
delete, when the album using the selected pieces of content is not purchased, the attribute associated with the user; and
store, when the album using the selected pieces of content is purchased, the attribute associated with the user.

3. The information processing system according to claim 1, wherein
each of the pieces of contents is assigned with at least one of a plurality of types of tags including a first tag and a second tag, and
the processor is configured to:
present, to the user, as recommended pieces of content for when there is no attribute of the user, a plurality of recommended pieces of content to allow a number of pieces of content assigned with the first tag and a number of pieces of content assigned with the second tag to correspond to each other;
when a first attribute corresponding to the first tag is identified as the attribute of the user, present to the user, as the recommended pieces of content based on the identified attribute, a plurality of recommended pieces of content to allow the number of pieces of content assigned with the first tag to be greater than the number of pieces of content assigned with the second tag; and
when a second attribute corresponding to the second tag is identified as the attribute of the user, present to the user, as the recommended pieces of content based on the identified attribute, a plurality of recommended pieces of content to allow the number of pieces of content assigned with the second tag to be greater than the number of pieces of content assigned with the first tag.

4. The information processing system according to claim 3, wherein the processor is configured to:
when the recommended pieces of content based on the identified attribute are presented to the user, present to the user, the plurality of recommended pieces of content to include a predetermined lower limit number of the pieces of content assigned with the first tag and a predetermined lower limit number of the pieces of content assigned with the second tag.

5. The information processing system according to claim 3, wherein the first tag includes information identifying a person that each of the pieces of content represents, and
the first attribute includes a plurality of attributes each indicating a preference for a different person.

6. The information processing system according to claim 1, wherein the processor is configured to:
propose a layout of each of pages of the album; and
change the recommended pieces of content in accordance with the layout of each of the pages of the album.

7. The information processing system according to claim 5, wherein the processor is configured to:
propose a layout of each of pages of the album; and
present, for pages that are in the layout representing a two-page spread style, the recommended pieces of content including pieces of content indicating, at its center, the preferred person that the identified first attribute indicates.

8. The information processing system according to claim 3, wherein
the pieces of content each represent an event where a plurality of persons appear,
the second tag includes information indicating that all of the persons appearing at the event or a group including at least two of the persons appearing at the event is represented,
the second attribute is an attribute indicating a preference for all or a group of some of the persons appearing at the event, and
the processor is configured to:
propose a layout of each of pages of the album; and
present, for pages that are in the layout representing a two-page spread style and that correspond to a final page, the recommended pieces of content including pieces of content assigned with the second tag.

9. The information processing system according to claim 1, wherein the processor is configured to:
present, as the recommended pieces of content, a plurality of pieces of content with an inter-content degree of similarity below a threshold value.

10. The information processing system according to claim 1, wherein
the pieces of content each represent an event,
a ticket for participating in the event indicates a two-dimensional code for creating the album corresponding to the event, and
the processor is configured to:
present, when information indicating the two-dimensional code is received from the user, the recommended pieces of content from among a plurality of pieces of content representing the event corresponding to the two-dimensional code.

11. The information processing system according to claim 10, wherein
the event includes events held a plurality of times, and
the processor is configured to:
present, when no information indicating the two-dimensional code is received from the user, the recommended pieces of content from among a plurality of pieces of content representing the events held a plurality of times.

12. A non-transitory computer readable medium storing an information processing program causing a computer to execute a process for using pieces of content that a user selects to create an album, the process comprising
when the user for whom no attribute has been set selects pieces of content to be included in the album, presenting to the user, recommended pieces of content for when there is no attribute of a user, and
when the user has selected a predetermined number of pieces of content, associating an attribute identified based on the selected pieces of content with the user, and, presenting, to the user, the recommended pieces of content based on the identified attribute by using an estimation model that estimates recommended pieces of content based on an attribute of a user.
